(19) United States
(12) Patent Application Publication
(10) Pub. No.: US 2026/0016086 A1
(43) Pub. Date: Jan. 15, 2026

(54) Method and Controller for Acquiring Characteristic Values of Frictionally Engaged Shifting Element of a Transmission, and Transmission Controller

(71) Applicant: ZF Friedrichshafen AG, Friedrichshafen (DE)

(72) Inventors: Robert Strauch, Ravensburg (DE); Anton Fritzer, Markdorf (DE); Stefan Schleweck, Hohentengen-Völlkofen (DE); Peter Emmerich, Wallerfangen (DE); Stephan Assmus, Etzling (FR)

(21) Appl. No.: 18/880,049

(22) PCT Filed: Jun. 19, 2023
(86) PCT No.: PCT/EP2023/066361

§ 371 Date: Dec. 30, 2024

(30) Foreign Application Priority Data
Jun. 30, 2022 (DE) 102022206718.5

(51) Int. Cl. F16H 61/06; F16H 61/00

(52) U.S. Cl. CPC F16H 61/061; F16H 2061/0068; F16H 2061/064

(57) ABSTRACT

Example aspects of the invention provide a method for ascertaining at least one characteristic value of a friction-locking shift element of a transmission with multiple shift elements. A first number of shift elements is engaged and a second number of shift elements is disengaged in each non-positive gear. To ascertain the at least one characteristic value of a defined friction-locking shift element, the transmission is operated on a test stand. A third number of shift elements is engaged, and the defined friction-locking shift element is subsequently actuated by an actuation signal close to the specific point at which the friction-locking shift element engages with slip. A defined rotational speed is applied at each of the transmission input and the transmission output, and a forming torque is measured. The respective forming stationary or quasi-stationary torque is recorded and stored together with the respective target current or target pressure or an actual current or actual pressure.

### CROSS-REFERENCE TO RELATED APPLICATIONS

The present application is related and has right of priority to German Patent Application No. DE 102022206718.5 filed on Jun. 30, 2022 and is U.S. National Phase of PCT/EP2023/066361 filed on Jun. 19, 2023, both of which are incorporated by reference in their entireties for all purposes.

### TECHNICAL FIELD

The invention relates generally to a method for ascertaining characteristic values of a friction-locking shift element of a transmission. The invention further relates generally to a control unit for carrying out the method and to a transmission control unit.

### BACKGROUND

A drive train of a motor vehicle includes a propulsion unit and a transmission connected between the propulsion unit and a drive output. The transmission converts rotational speeds and torques and provides the available tractive force of the propulsion unit at the drive output.

The transmission of a vehicle includes multiple shift elements, which can be in the form of friction-locking shift elements and/or positive-locking shift elements. A friction-locking shift element is, in particular, a clutch or a brake. A positive-locking shift element is, in particular, a dog. In every engaged gear of a transmission, a first number of the shift elements of the transmission is engaged and a second number of the shift elements of the transmission is disengaged. In order to implement a gear change of the transmission, at least one previously engaged shift element is disengaged and at least one previously disengaged shift element is engaged.

For the case in which the transmission has a hydrodynamic starting component with a torque converter and a torque converter lockup clutch, the torque converter lockup clutch also belongs to the first number of shift elements that are engaged in a non-positive gear.

In order to disengage and engage a shift element, the shift element is actuated, proceeding from a transmission control unit, by an actuation signal. This typically takes place via a hydraulic pressure actuation for the positive-locking shift element. Depending on the pressure actuation, the friction-locking shift element is to transmit a defined torque.

Instead of a pressure actuation, an electrical current actuation can also be used. The pressure that is to set in due to an electrical current actuation depends on the valve characteristic curve of a hydraulic valve which interacts with the friction-locking shift element.

In order to be able to carry out, in particular, gear changes with high quality, the pressure actuation or the current actuation for the friction-locking shift element must be particularly accurate. Characteristic values for a pressure actuation or a current actuation of a friction-locking shift element are stored in the transmission control unit. Previously, the characteristic values stored in the transmission control unit by the transmission manufacturer have merely been basic values, by which gear changes can be carried out, although typically not with sufficient shift quality, since transmissions can deviate from one another with respect to component tolerances.

Therefore, according to practical experience, the characteristic values stored in the transmission control unit by the manufacturer have been adapted via an adaptation, which adaptation is carried out in the vehicle during the operation of the motor vehicle during an initial adaptation of a new vehicle. The ultimately achievable shift quality depends on the quality of the characteristic values stored by the manufacturer and on the sensor system installed in the vehicle, which sensor system delivers measured values for the adaptation.

From DE 102 38 474 A1, it is already known to adapt shift processes of a transmission on a test stand. This enables characteristic values that are already better at the manufacturer to be provided in order to increase the achievable shift quality.

DE 10 2007 040 485 A1 relates to one further method for generating adaptation data for shift processes of a transmission.

There is a need to ascertain characteristic values of friction-locking shift elements of a transmission even more accurately at the manufacturer in order to store more accurate characteristic values in the transmission control unit at the manufacturer.

### SUMMARY

Example aspects of the invention provide a method and control unit for ascertaining at least one characteristic value of a friction-locking shift element of a transmission, and a transmission control unit.

A first example aspect of the invention provides a method for ascertaining at least one characteristic value of a friction-locking shift element of a transmission, in order to ascertain the at least one characteristic value of a defined friction-locking shift element, the transmission is operated on a test stand as follows.

A third number of shift elements of the transmission is engaged, which third number is one fewer than the first number of shift elements of the transmission, wherein the third number of shift elements does not include the defined friction-locking shift element for which the at least one characteristic value is ascertained, and wherein the shift elements of the third number of shift elements are not further engaged to a slipping condition.

The first number of shift elements is the number of shift elements that is engaged in an engaged and thus non-positive gear of the transmission. The first number of shift elements also includes, for the case in which the transmission has a hydrodynamic starting component, the torque converter lockup clutch of the hydrodynamic starting component.

The defined friction-locking shift element of the transmission, for which the at least one characteristic value is ascertained, is subsequently actuated by an actuation signal, specifically a target current or a target pressure, for engagement with slip, wherein a defined rotational speed is applied at each of the transmission input and the transmission output in the process, and a forming torque, specifically an output torque forming at the transmission output or an input torque forming at the transmission output, is measured.

For the actuation signal, specifically the target current or the target pressure, the respective forming stationary or quasi-stationary torque, specifically the stationary or quasi-stationary output torque or input torque, is recorded according to example aspects the invention close to the specific point of the friction-locking shift element and stored together with the respective target current or the respective target pressure or a respective actual current, which is dependent on the respective actuation signal, or a respective actual pressure, which is dependent on the respective actuation signal, in order to ascertain a current-torque characteristic curve or a pressure-torque characteristic curve, specifically a current-output torque characteristic curve or a pressure-output torque characteristic curve or a current-input torque characteristic curve or a pressure-input torque characteristic curve, as the characteristic value of the defined friction-locking shifting element.

As set forth in the present application, the specific point refers to the torque value selected for the particular clutch or the torque value selected for the defined friction-locking shift element, or the torque defined for a particular shift element.

This recording of the forming torque close or as close as possible to the specific point has the advantage that measurement errors can be kept as low as possible. As set forth in the present invention, the term “close” to the specific point means that the respective specific points define a pressure-torque characteristic curve and that the forming torque is recorded, for example, up to a half (0.5) bar above the torque transmission.

By the method according to example aspects of the invention, it is possible to easily and accurately ascertain, at the transmission manufacturer, a current-output torque characteristic curve or a pressure-output torque characteristic curve or a current-input torque characteristic curve or a pressure-input torque characteristic curve for each friction-locking shift element of a transmission on a test stand and to store the corresponding characteristic curve in the transmission control unit. By the method according to example aspects of the invention, it is finally possible to carry out shift processes more precisely with higher shift quality, in particular without the need for an initial adaptation of a new vehicle.

Whether the input torque or the output torque is ascertained for the particular defined friction-locking shift element depends in particular on whether a torque sensor for the input torque and/or a torque sensor for the output torque are/is installed on the test stand. If the test stand only has a torque sensor for the input torque, the input torque is recorded. If the test stand only has a torque sensor for the output torque, the output torque is recorded. If the test stand has a torque sensor for the input torque and a torque sensor for the output torque, either the output torque or the input torque is recorded, in particular depending on whether the inertial mass of the transmission is lower with respect to the transmission input or the transmission output for the particular shift element.

If the inertial mass of the transmission with respect to the transmission input is lower than the inertial mass with respect to the transmission output for the particular shift element, the input torque is recorded for the particular shift element. If the inertial mass of the transmission with respect to the transmission output is lower than the inertial mass with respect to the transmission input for the particular shift element, the output torque is recorded for the particular shift element.

Preferably, the actuation signal is a target current pulse or a target pressure pulse having a defined magnitude or a defined level or a defined value, which is applied for as long as it takes until a stationary or quasi-stationary output torque at the transmission output is recorded or until a stationary or quasi-stationary input torque at the transmission input is recorded. A stationary output torque or input torque is constant. A quasi-stationary output torque or input torque is approximately constant and the time gradient thereof is lower than a limit value. These features are particularly preferred in order to easily and accurately ascertain, on the test stand, the at least one characteristic value of the defined friction-locking shift element of the transmission.

Preferably, the current-output torque characteristic curve or the pressure-output torque characteristic curve is ascertained depending on a mean friction value.

As set forth in the present application, a mean friction value means that a mean value of friction values of a defined friction-locking shift element measured on the test stand and/or a theoretical friction value of a defined friction-locking shift element are/is selected.

Preferably, the particular characteristic value, be it the pressure-torque characteristic curve and/or the current-torque characteristic curve and/or the filling time and/or the filling volume characteristic curve, is ascertained depending on a transmission oil temperature. As a result, it is possible to adapt the stored characteristic value depending on the actual transmission oil temperature and to further increase the achievable shift quality during the operation of a motor vehicle.

Preferred developments can be found in the following description.

### BRIEF DESCRIPTION OF THE DRAWINGS

Exemplary embodiments of the invention are explained in greater detail with reference to the drawings, without being limited thereto, wherein:

FIG. 1 shows a block diagram of a test stand of a transmission together with a transmission; and

FIG. 2 shows a timing chart for illustrating example aspects of the invention.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

Example aspects of invention relates to a method and to a control unit for ascertaining at least one characteristic value of friction-locking shift elements of a transmission, specifically a motor vehicle transmission. Example aspects of the invention further relate to a transmission control unit, which controls the operation of a transmission by way of an open-loop and/or closed-loop system.

It is known that a transmission of a motor vehicle has multiple shift elements. The shift elements can be friction-locking shift elements and positive-locking shift elements. Friction-locking shift elements can be in the form of clutches or brakes. Positive-locking shift elements can be in the form of dogs.

In every non-positive gear of a transmission, a first number of the shift elements of the transmission is engaged and a second number of the shift elements of the transmission is disengaged. Transmissions are known from practical experience that have five shift elements, wherein, in each non-positive shift element, three shift elements are engaged and two shift elements are disengaged.

For the case in which the transmission has a hydrodynamic starting component with a torque converter and a torque converter lockup clutch, the torque converter lockup clutch also belongs to the first number of shift elements that are engaged in an engaged and thus non-positive gear.

In order to implement a gear change and thus to carry out a gear shift in the transmission, at least one previously engaged shift element is disengaged and at least one previously disengaged shift element is engaged.

The control, in particular, of the friction-locking shift elements of the transmission is carried out via a particular actuation signal of a transmission control unit, wherein the actuation signal can be an electrical current actuation signal in the form of an electrical target current for a hydraulic valve interacting with the friction-locking shift element or a hydraulic pressure actuation signal in the form of a hydraulic target pressure.

There is a correlation between the electric control current and the hydraulic control pressure via a valve characteristic curve of the particular hydraulic valve. Valve characteristic curves are stored in the transmission control unit of the transmission.

Example aspects of the invention then relate to ascertaining a characteristic value for at least one defined friction-locking shift element of the transmission, wherein this characteristic value ascertainment for the defined friction-locking shift element of the transmission can be carried out easily and accurately by the manufacturer on a test stand of the transmission.

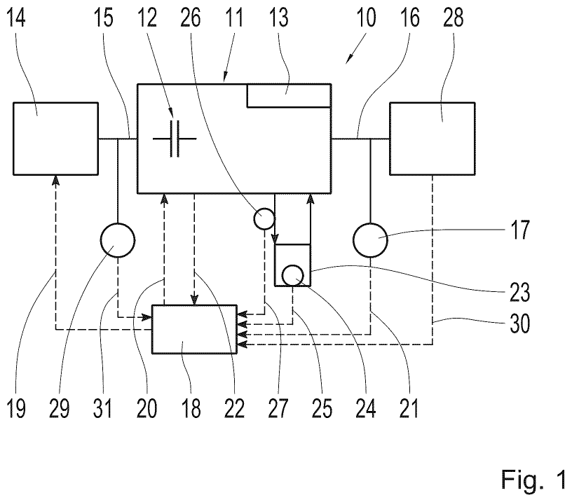

FIG. 1 shows a block diagram of a test stand 10 for a transmission 11 together with a transmission 11 which is kept available on the test stand 10. FIG. 1 shows, by way of example, one friction-locking shift element 12 of the transmission 11, for which at least one characteristic value is to be ascertained.

FIG. 1 also shows a transmission control unit 13 of the transmission 11, in which the at least one characteristic value ascertained for the friction-locking shift element 12 is stored after having been ascertained.

The test stand 10 includes a drive source 14 in order to adjust an input rotational speed at a transmission input 15 of the transmission 11. An output rotational speed can be adjusted at a transmission output 16 of the transmission 11 via a load 28. In FIG. 1, a torque sensor 17 is connected to the transmission output 16, via which torque sensor an output torque of the transmission 11 can be measured. Alternatively or additionally, a torque sensor 29 can be connected to the transmission input 15, via which torque sensor an input torque of the transmission 11 can be measured.

FIG. 1 also shows a control unit 18 of the test stand 10.

The control unit 18 can actuate, by an output variable 19, the drive source 14 of the test stand 10. Depending on the output variable 19 of the control unit 18, the drive source 14 adjusts, in particular, an input rotational speed at the transmission input 15 of the transmission 11.

The control unit 18 can actuate, by an output variable 30, the load 28 of the test stand 10. Depending on the output variable 30 of the control unit 18, the load 28 adjusts, in particular, an output rotational speed at the transmission output 16 of the transmission 11.

Via a further output variable 20, the control unit 18 of the test stand 10 can actuate the transmission 11, which is to be adapted on the test stand 10, specifically the shift elements 12 of the transmission 11 for disengagement or engagement. In the following, it is assumed that the output variable 20 of the control unit 18 is an output variable, by which the friction-locking shift element 12 of the transmission 11, for which at least one characteristic value is to be ascertained on the test stand 10, is actuated. The output variable 20 of the control unit 18 is therefore an actuation signal, specifically a target current or a target pressure, for the friction-locking shift element 12 of the transmission 11, for which at least one characteristic value is to be ascertained on the test stand 10.

The control unit 18 outputs, as the output variable 20, either an electrical target current actuation signal or a hydraulic target pressure actuation signal and provides this to the transmission 11. There is a correlation between the target current or the target pressure via the valve characteristic curve of the hydraulic valve interacting with the shift element 12.

A measured value of the torque sensor 17 can be provided to the control unit 18 of the test stand 10. Alternatively or additionally, the torque sensor 29 can provide a measured value as an input variable 31 for the control unit 18.

Furthermore, the control unit 18 of the test stand 10 receives an input variable 22 from the transmission 11. The input variable 22 can be an electrical actual current or a hydraulic actual pressure, which actually forms on the basis of the target current or the target pressure. The actual current can be measured. The actual pressure can be calculated on the basis of the actual current. There is a correlation between the actual current or the actual pressure via the valve characteristic curve of the hydraulic valve interacting with the shift element 12.

The calculation of the hydraulic actual pressure on the basis of the electrical actual current can be carried out by the control unit 18 of the test stand 10 or by the transmission control unit 13.

A further assembly of the test stand 10 shown in FIG. 1 is an oil cooler 23. The oil cooler 23 is used to cool the hydraulic oil of the transmission 11.

Using a temperature sensor 24, the temperature of the hydraulic oil can be recorded and provided as an input variable 25 to the control unit 18 of the test stand 10. Using a pressure sensor 26, a pressure of the oil, in particular in the inflow to the oil cooler 23, can be measured and provided as a further input variable 27 to the control unit 18 of the test stand 10.

In order to then ascertain at least one characteristic value for a defined friction-locking shift element 12 of the transmission 11 on the test stand 10, the transmission 11 is operated on the test stand 10 as follows.

Initially, a third number of shift elements of the transmission 11 is engaged, which third number is one fewer than the first number of shift elements that is engaged in a non-positive gear of the transmission 11. Therefore, if three shift elements are engaged in a non-positive gear, the third number of shift elements is two. If four shift elements are engaged in a non-positive gear, the third number of shift elements is three.

This third number of shift elements does not include the defined friction-locking shift element 12 for which the at least one characteristic value is to be ascertained.

The first number of shift elements is the number of shift elements that is engaged in an engaged and thus non-positive gear of the transmission. The first number of shift elements also includes, for the case in which the transmission 11 has a hydrodynamic starting component, the torque converter lockup clutch of the hydrodynamic starting component.

The shift elements of the third number of shift elements, which third number is one fewer than the first number of shift elements, are not engaged to a slipping condition, i.e., completely in particular using excess contact pressure. The third number of shift elements can also include a positive-locking shift element.

The defined shift element 12, for which the at least one characteristic value is to be ascertained, is actuated for engagement with slip by an actuation signal close to the specific point of the friction-locking shift element, in particular by a target current pulse or a target pressure pulse.

For the current pulse or the pressure pulse, the output torque forming at the transmission output 16 is measured using the torque sensor 17 or the input torque forming at the transmission input 15 is measured using the torque sensor 29 at a defined input rotational speed applied at the transmission input 15 and at a defined output rotational speed applied at the transmission output 16. The input rotational speed and the output rotational speed are each selected such that the slip forms at the defined shift element 12 for which the at least one characteristic value is to be ascertained.

If the test stand 10 includes the torque sensor 29 for the input torque and the torque sensor 17 for the output torque, either the output torque or the input torque is measured, in particular depending on whether the inertial mass of the transmission is lower with respect to the transmission input 15 or the transmission output 16 for the particular shift element. If the inertial mass of the transmission with respect to the transmission input 15 is lower than the inertial mass with respect to the transmission output 16 for the particular shift element 12, the input torque is measured using the torque sensor 29 for the particular shift element 12. If the inertial mass of the transmission with respect to the transmission output 16 is lower than the inertial mass with respect to the transmission input 15 for the particular shift element 12, the output torque is measured using the torque sensor 17 for the particular shift element 12. If the test stand 10 has only the torque sensor 29 for the input torque, the input torque is measured. If the test stand has only the torque sensor 17 for the output torque, the output torque is measured.

The actuation signal is a target current pulse or a target pressure pulse having a defined magnitude or a defined level or a defined value, which is applied for as long as it takes until a stationary or quasi-stationary output torque at the transmission output 16 is recorded or until a stationary or quasi-stationary input torque at the transmission input 15 is recorded. A stationary torque is constant. A quasi-stationary torque is approximately constant and the time gradient thereof is lower than a limit value.

For the target current pulse or the target pressure pulse, the respective forming stationary or quasi-stationary output torque at the transmission output 16 is recorded using the torque sensor 17, or the respective forming stationary or quasi-stationary input torque at the transmission input 15 is recorded using the torque sensor 29, wherein the particular measured torque is stored together with the magnitude or the level or the value of the particular target current or target pressure or of the actual current or of the actual pressure as a value pair in the control unit 18. Depending thereon, a current-torque characteristic curve or a pressure-torque characteristic curve is ascertained for the particular friction-locking shift element 12.

In this way, the current-torque characteristic curve that is ascertained can be a current-input torque characteristic curve or a current-output torque characteristic curve. The pressure-torque characteristic curve that is ascertained can be a pressure-input torque characteristic curve or a pressure-output torque characteristic curve.

The actuation of the particular friction-locking shift element 12 by the actuation signal is carried out via the output variable 20 of the control unit 18 of the test stand 10. This is, in particular, in each case, an electrical target current, specifically a target current pulse, for a hydraulic valve interacting with the friction-locking shift element 12. The actual electrical actual current that is dependent on the target current can be metrologically sensed, wherein the actual current can be provided as an input variable 22 to the control unit 18. The electrical actual current can be converted into the hydraulic actual pressure on the basis of a stored valve characteristic curve.

An ascertained current-torque characteristic curve can be a target current-torque characteristic curve or an actual current-torque curve. An ascertained pressure-torque characteristic curve can be a target pressure-torque characteristic curve or an actual pressure-torque characteristic curve.

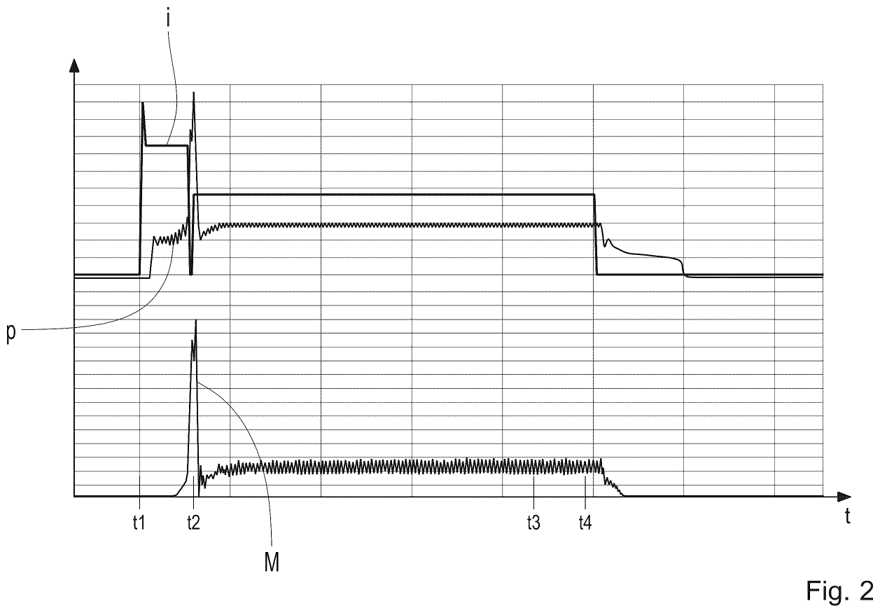

In FIG. 2, starting at the point in time t1 to the point in time t2, the defined friction-locking shift element 12, specifically the hydraulic valve thereof, is actuated for engagement with slip by the actuation signal in the form of an electrical target current pulse i close to the specific point at which the friction-locking shift element engages with slip. Depending on this target current pulse i, the output torque M forms at the transmission output 16. Depending on a measured electrical actual current, the hydraulic actual pressure p can be ascertained via calculation on the basis of the valve characteristic curve. The electrical target current pulse i is constant up to an inrush current immediately at the beginning of the target current pulse i.

For the case in which stationary or quasi-stationary conditions have formed between the points in time t3 and t4 for the output torque M, i.e., when a stationary or quasi-stationary output torque M is metrologically sensed, a current-output torque characteristic curve can be ascertained and stored for the target current pulse i depending on a mean friction value of a friction-locking shift element which is present.

As mentioned above, the forming hydraulic pressure can be calculated depending on the electrical current and the valve characteristic curve. In this way, the hydraulic target pressure can be calculated on the basis of the electrical target current and the hydraulic actual pressure can be calculated on the basis of the electrical actual current.

As mentioned above, in FIG. 2, alternatively to the output torque, the input torque at the transmission 11 can also be measured and thus recorded. Similarly, a current-input torque characteristic curve or a pressure-input torque characteristic curve can then be ascertained depending on a mean friction value.

Preferably, for the actuation signal, a volumetric flow guided or flowing to the friction-locking shift element 12 can be ascertained depending on the line resistance of a hydraulic line leading to the defined friction-locking shift element 12, wherein this volumetric flow is integrated over time in order to ascertain a filling volume of the particular friction-locking shift element 12. The following approach is preferably implemented for this purpose.

Depending on the previously ascertained pressure-torque characteristic curve, specifically the pressure-output torque characteristic curve or the pressure-input torque characteristic curve, and the measured torque profile over time, specifically the measured output torque profile or the input torque profile, an actual pressure profile over time is ascertained, specifically being calculated.

Depending on the actuation signal, in particular the target current profile, a target pressure profile over time is determined, in particular being calculated depending on the valve characteristic curve.

Depending on the difference between the actual pressure profile and the target pressure profile as well as on the line resistance of a hydraulic line leading to the defined friction-locking shift element 12, the volumetric flow guided to the friction-locking shift element 12 and, depending on the integration of the volumetric flow over time, the filling volume of the friction-locking shift element 12 is ascertained. Depending thereon, a further characteristic value that is ascertained is a current-filling volume characteristic curve or a pressure-filling volume characteristic curve. The calculation of the volumetric flow is therefore based on the pressure differential between the target pressure profile, which is dependent on the target current, and the actual pressure profile, which is dependent on the actual current.

Depending on the filling volume ascertained in this way, in particular, the pressure-filling volume (p-V) characteristic curve can be ascertained as a further characteristic value and stored in the transmission control unit 13.

The aforementioned characteristic curves can be ascertained individually on the test stand 10 for each friction-locking shift element 12 of a transmission 11.

Preferably, the particular characteristic curve is ascertained depending on a transmission oil temperature, which is measured using the temperature sensor 24 and provided to the control unit 18 of the test stand 10. In this way, it is possible to store the particular characteristic curve in the transmission control unit 13 depending on the transmission oil temperature and to adapt this characteristic curve during operation depending on a current transmission oil temperature.

It is therefore set forth in the invention to actuate a transmission 11 on a test stand 10, specifically a friction-locking shift element 12 of the transmission, for which at least one characteristic value is to be ascertained, for engagement with slip by actuation signals of different levels. In the process, both a current-torque characteristic curve and/or a pressure-torque characteristic curve can be ascertained, as well as a pressure-filling volume characteristic curve and/or a current-filling volume characteristic curve as well as a filling time for the particular friction-locking shift element 12.

Example aspects of the invention also relate to the control unit 18 of the transmission test stand 10, which is designed to carry out the method. For this purpose, the control unit 18 includes hardware-related means and software-related means.

The hardware-related means include data interfaces for exchanging data with the assemblies contributing to the execution of the method according to example aspects of the invention, such as, for example, with the drive source 14, the transmission 11, as well as the sensors 17, 26, 24. The hardware-related means also include a processor for data processing and a non-transitory memory for data storage. The software-related means include program modules and/or instructions, which are stored or implemented in the control unit to carry out the method according to example aspects of the invention.

Example aspects of invention further relates to the transmission control unit 13 in which characteristic values for the friction-locking shift elements 12 thereof are stored, which characteristic values have been ascertained using the above-described method according to example aspects of the invention and using the control unit 18 of the test stand 10 according to example aspects of the invention.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

10 test stand
11 transmission
12 friction-locking shift element
13 transmission control unit
14 drive source
15 transmission input
16 transmission output
17 torque sensor
18 test stand control unit
19 output variable
20 output variable
21 input variable
22 input variable
23 test stand oil cooler
24 temperature sensor
25 input variable
26 pressure sensor
27 input variable
28 load
29 torque sensor
30 output variable
31 input variable
i target current
M measured actual torque
p calculated actual pressure

1-6: (canceled)

7. A method for ascertaining at least one characteristic value of a friction-locking shift element (12) of a transmission (11) that includes a plurality of shift elements, wherein, in each non-positive gear of the transmission (11) a first number of shift elements of the transmission (11) is engaged and a second number of shift elements of the transmission (11) is disengaged, wherein, in order to ascertain the at least one characteristic value of a defined friction-locking shift element (12), the method comprises operating the transmission (11) on a test stand (10) as follows:
engaging a third number of shift elements of the transmission (11), the third number being one fewer than the first number of shift elements, the third number of shift elements does not include the defined friction-locking shift element (12), and the shift elements of the third number of shift elements are not engaged for slip;
actuating the defined friction-locking shift element (12) for engagement with slip by an actuation signal close to an actuation signal that comprises a target current or a target pressure of the defined friction-locking shift element (12);
applying a defined rotational speed at each of the transmission input (15) and the transmission output (16);
measuring an output torque forming at the transmission output (16) and/or an input torque forming at the transmission input (15); and
recording and storing the respectively forming stationary or quasi-stationary output torque or input torque at the target current or the target pressure together with the respective target current or target pressure or an actual current or actual pressure dependent on the respective actuation signal in order to ascertain a current-output torque characteristic curve or pressure-output torque characteristic curve or a current-input torque characteristic curve or a pressure-input torque characteristic curve as the characteristic value of the defined friction-locking shifting element (12).

8. The method of claim 7, wherein the actuation signal comprises a target current pulse or a target pressure pulse having a defined magnitude or a defined level or a defined value, which is applied until a stationary or quasi-stationary output torque at the transmission output (16) is recorded or until a stationary or quasi-stationary input torque at the transmission input (15) is recorded.

9. The method of claim 7, wherein the current-output torque characteristic curve or the pressure-output torque characteristic curve or the current-input torque characteristic curve or the pressure-input torque characteristic curve is ascertained depending on a mean friction value.

10. The method of claim 7, wherein the particular characteristic value is ascertained depending on a transmission oil temperature.

11. A control device (18) of a transmission test stand (19) for ascertaining characteristic values of friction-locking shift elements (12) of a transmission (11), wherein the control unit (18) is configured to automatically carry out the method of claim 7.

12. A transmission control unit (13) of a transmission (11) of a motor vehicle for open-loop and/or closed-loop control of the transmission (11), wherein characteristic values of friction-locking shift elements (12) of the transmission (11) are stored in the transmission control unit (13), the characteristic values ascertained using the method of claim 7.
